(19) United States
(12) Patent Application Publication
(10) Pub. No.: US 2018/0222407 A1
(43) Pub. Date: Aug. 9, 2018

(54) APPARATUS, CONTROL METHOD THEREOF AND RECORDING MEDIA

(71) Applicant: Samsung Electronics Co., Ltd., Suwon-si (KR)

(72) Inventors: Jae-woo SEO, Suwon-si (KR); Hee Chan HAN, Seoul (KR); Byung Il KWAK, Seoul (KR); Huy Kang KIM, Seoul (KR); Byung-ho CHA, Suwon-si (KR)

(73) Assignee: Korea University Research and Business Foundation, Seoul (KR)

(21) Appl. No.: 15/878,013

(22) Filed: Jan. 23, 2018

(30) Foreign Application Priority Data
Feb. 6, 2017 (KR) 10-2017-0016450

(51) Int. Cl. B60R 16/023; G07C 5/08; G01M 17/00

(52) U.S. Cl. CPC B60R 16/0232; G01M 17/00; G07C 5/0808; G07C 5/0816

(57) ABSTRACT

An apparatus is provided. The apparatus includes a detector configured to detect a state of the apparatus, and a processor configured to determine a current change degree of an apparatus state between a current point of time and a previous point of time based on a first change value of the apparatus state at the current point of time and a second change value of the apparatus state at the previous point of time earlier than the current point of time, and determine whether change in the apparatus state is normal or abnormal based on a result of comparison between the determined current change degree and an accumulated change degree of the apparatus state accumulated for a predetermined time section before the current point of time.

### CROSS-REFERENCE TO RELATED THE APPLICATION(S)

This application claims the benefit under 35 U.S.C. § 119(a) of a Korean patent application filed on Feb. 6, 2017 in the Korean Intellectual Property Office and assigned Serial number 10-2017-0016450, the entire disclosure of which is hereby incorporated by reference.

### JOINT RESEARCH AGREEMENT

The present disclosure was made by or on behalf of the below listed parties to a joint research agreement. The joint research agreement was in effect on or before the date the present disclosure was made and the present disclosure was made as a result of activities undertaken within the scope of the joint research agreement. The parties to the joint research agreement are 1) Samsung Electronics Co., Ltd. 2) Korea University Research and Business Foundation.

### TECHNICAL FIELD

The present disclosure relates to an apparatus, which includes various sensors and processes detected results output from the sensors, a method of controlling the same, and a recording medium. More particularly, the present disclosure relates to an apparatus, which is directly installed in or remotely connected to a vehicle or the like machine and senses something wrong with the machine, a method of controlling the same, and a recording medium.

### BACKGROUND

To compute and process predetermined information in accordance with certain processes, an electronic apparatus basically includes a central processing unit (CPU), a chipset, a memory, and the like electronic components for computation. Such an electronic apparatus may be classified variously in accordance with what information will be processed therein. For example, the electronic apparatus is classified into an information processing apparatus, such as a personal computer, a server or the like for processing general information, and an image processing apparatus for processing image information. As one of various fields, in which the electronic apparatus can be utilized, there is an electronic apparatus that is directly installed in or remotely connected to a machine and manages and controls the machine.

To use the vehicle for example, the vehicle is an aggregate of various mechanical parts and electronic parts of the vehicle. These parts independently or interactively operate in a microscopic perspective, and thus the general and macroscopic operations of the vehicle are finally made. The electronic apparatus monitors the operations of the vehicle through various sensors and therefore determines whether the vehicle is normal or abnormal.

One of methods used by the electronic apparatus to determine a state of a vehicle is as follows. When the sensor outputs a digitized parameter of showing the state of the vehicle, the electronic apparatus compares the parameter with a preset threshold value and determines the state of the vehicle.

By the way, since an operation is performed by the aggregate of many parts, it may be not accurate that the whole state of the vehicle is determined by the electronic apparatus based on detected results of just one sensor. The vehicle may be confronted with various unexpected situations while being driven. For example, even when a revolution per minute (RPM) or temperature of an engine is just higher than a threshold value, it is difficult to prove the vehicle abnormal. In other words, if abnormality is determined based on comparison between values detected by one or some sensors and preset threshold values, the accuracy in the determination may be low in case of many unexpected situations like those in a vehicle.

In addition, there are about 60 or more digitized parameters typically derived from a vehicle and showing the states of the vehicle. Since it is not easy to ultimately determine the abnormality of the vehicle by individually determining such many parameters, a more comprehensive determining method is required.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus, which includes various sensors and processes detected results output from the sensors, a method of controlling the same, and a recording medium.

In accordance with an aspect of the present disclosure, an apparatus is provided. The apparatus includes a detector configured to detect a state of the apparatus, and at least one processor configured to determine a current change degree of an apparatus state between a current point of time and a previous point of time based on a first change value of the apparatus state at the current point of time and a second change value of the apparatus state at the previous point of time earlier than the current point of time, and determine whether change in the apparatus state is normal or abnormal based on a result of comparison between the determined current change degree and an accumulated change degree of the apparatus state accumulated for a predetermined time section before the current point of time. Thus, the apparatus determines whether the change in the state of the apparatus by a lapse of time complies with the attributes of the apparatus, thereby ultimately having high accuracy in determining whether the state of the apparatus is normal or abnormal at the current point of time.

The at least one processor may determine that the change in the apparatus is normal when a difference between the determined current change degree and the accumulated change degree is relatively large, and may determine that the change in the apparatus state is abnormal when the difference is relatively small.

The apparatus may further include a display, wherein the at least one processor may process a user interface (UI), which informs the abnormality of the apparatus state, to be displayed on the display when it is determined that the change in the apparatus state is abnormal. Thus, the apparatus can inform a user of the abnormality of the current state.

The at least one processor may determine the current change degree by determining similarity between the first change value and the second change value based on cosine similarity.

The at least one processor may calculate change values in the apparatus state at a plurality of points of time within the predetermined time section based on cosine similarity, and may determine the accumulated change degree of the apparatus states based on a mean value of the calculated change values.

The at least one processor may calculate the first change value based on a first difference value between a state value of showing the apparatus state at the current point of time and a state value of showing the apparatus state at the first point of time before the current point of time.

The at least one processor may calculate the second change value based on a second difference value between the state value at the first point of time and the state value of showing the apparatus state at a second point of time before the first point of time.

The detector may include a plurality of sensors configured to detect the states of the apparatus, and the at least one processor may generate the state value of the apparatus at the points of time by vectorizing pieces of detected information respectively output from the plurality of sensors at a certain point of time. Thus, the apparatus pieces together the plurality of pieces of detected information collected at a certain point of time into one state value corresponding to the corresponding point of time, thereby making it easy to perform calculating and process.

In accordance with an aspect of the present disclosure, a method of controlling an apparatus is provided. The method includes detecting a state of the apparatus, determining a current change degree of an apparatus state between a current point of time and a previous point of time based on a first change value of the apparatus state at the current point of time and a second change value of the apparatus state at the previous point of time earlier than the current point of time, and determining whether change in the apparatus state is normal or abnormal based on a result of comparison between the determined current change degree and an accumulated change degree of the apparatus state accumulated for a predetermined time section before the current point of time.

The determining of whether the change in the apparatus state is normal or abnormal may include: determining that the change in the apparatus is normal when a difference between the determined current change degree and the accumulated change degree is relatively large, and determining that the change in the apparatus state is abnormal when the difference is relatively small.

The determining of that the change in the apparatus state is abnormal may include: displaying a UI which informs the abnormality of the apparatus state.

The determining of the current change degree of the apparatus state may include: determining of the current change degree by determining similarity between the first change value and the second change value based on cosine similarity.

The determining of whether the change in the apparatus state is normal or abnormal may include: calculating change values in the apparatus state at a plurality of points of time within the predetermined time section based on cosine similarity, and determining the accumulated change degree of the apparatus states based on a mean value of the calculated change values.

The determining of the current change degree of the apparatus state may include calculating the first change value based on a first difference value between a state value of showing the apparatus state at the current point of time and a state value of showing the apparatus state at the first point of time before the current point of time.

The determining of the current change degree of the apparatus state may include calculating the second change value based on a second difference value between the state value at the first point of time and the state value of showing the apparatus state at a second point of time before the first point of time.

The detecting the states of the apparatus may include generating the state value of the apparatus at the points of time by vectorizing pieces of detected information respectively output from a plurality of sensors at a certain point of time.

In accordance with another aspect of the present disclosure, at least one non-transitory recording medium, in which a program code of a method provided to be implemented by at least one processor of an apparatus is stored is provided. The method includes detecting a state of the apparatus, determining a current change degree of an apparatus state between a current point of time and a previous point of time based on a first change value of the apparatus state at the current point of time and a second change value of the apparatus state at the previous point of time earlier than the current point of time, and determining whether change in the apparatus state is normal or abnormal based on a result of comparison between the determined current change degree and an accumulated change degree of the apparatus state accumulated for a predetermined time section before the current point of time.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic apparatus according to an embodiment of the present disclosure;

FIG. 2 is a flowchart illustrating operations of an electronic apparatus according to an embodiment of the present disclosure;

FIG. 3 is a flowchart illustrating operations of a collection module in an electronic apparatus according to an embodiment of the present disclosure;

FIG. 4 illustrates a principle that an analysis module divides time sections for analysis of state changes in an electronic apparatus according to an embodiment of the present disclosure;

FIG. 5 is a flowchart illustrating operations of an analysis module in an electronic apparatus according to an embodiment of the present disclosure; and

FIG. 6 is a block diagram of an electronic apparatus according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In the description of the embodiments of the present disclosure, an ordinal number used in terms, such as a first element, a second element, and the like, is employed for describing variety of elements, and the terms are used for distinguishing between one element and another element. Therefore, the meanings of the elements are not limited by the terms, and the terms are also used just for explaining the corresponding embodiment without limiting the idea of the present disclosure. Further, the embodiments will describe only elements directly related to the idea of the present disclosure, and description of the other elements will be omitted. However, it will be appreciated that the elements, the descriptions of which are omitted, are not unnecessary to realize the apparatus or system according to the embodiments.

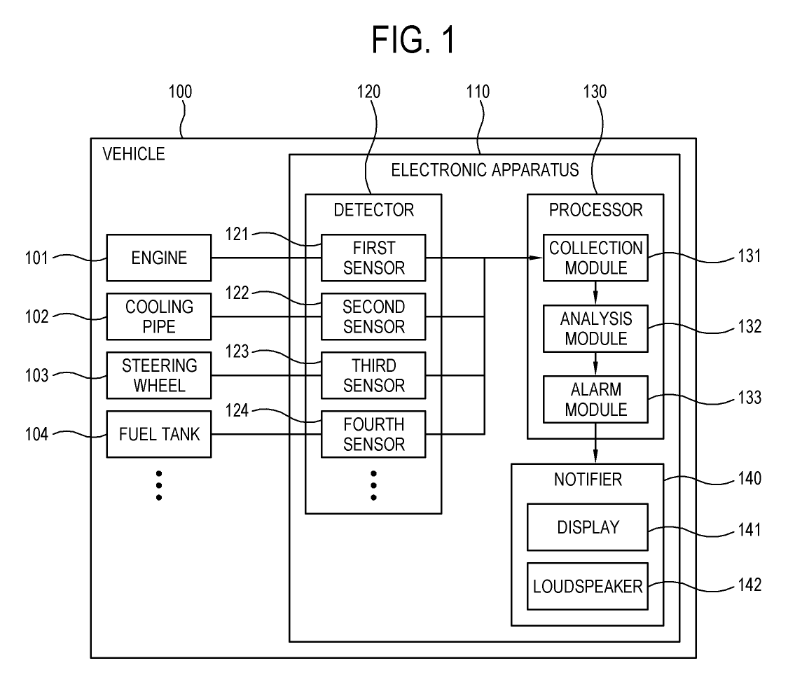

FIG. 1 is a block diagram of an electronic apparatus according to an embodiment of the present disclosure.

Referring to FIG. 1, an electronic apparatus 110 is installed in a vehicle 100, and configured to determine and manage the state of the vehicle 100. In an embodiment of the present disclosure, the electronic apparatus 110 is directly installed in a main body of the vehicle 100 and thus involved in the vehicle 100, but not limited thereto. Alternatively, the electronic apparatus 110 may include at least one element separated from the main body of the vehicle 100. Further, an object to be managed by the electronic apparatus 110 according to one embodiment is not limited to only the vehicle 100, and various kinds of equipment and devices may be managed by the electronic apparatus 110. For example, the electronic apparatus 110 may be provided to manage various kinds of machines, home appliances, other electronic apparatus, and the like.

When the electronic apparatus 110 is installed in the vehicle 100, all the elements of the electronic apparatus 110 are regarded as the elements of the vehicle 100. For example, some elements of the vehicle, which are to realize the present inventive concept in the vehicle 100, will be commonly called the electronic apparatus 110 in this embodiment.

Alternatively, the electronic apparatus 110 may be detachably installed in the vehicle 100 and replaceable as necessary by separation from the vehicle 100. In this case, the electronic apparatus 110 refers to one unit element for achieving the present inventive concept among the elements of the vehicle 100.

The electronic apparatus 110 includes a detector 120 to detect the states of the vehicle 100, a processor 130 to perform preset processes in accordance with the detected results of the detector 120, and a notifier 140 to notify a user of the processed results of the processor 130. The detector 120, the processor 130 and the notifier 140 are provided to exchange data with one another through wiring in the vehicle 100.

The detector 120 measures parameters of showing the current states of the vehicle 100 in various aspects or viewpoints. Various parameters may be used in explaining what state the vehicle 100 is in. For example, the vehicle 100 may include parts, such as an engine 101 which generates power for driving, a cooling pipe 102 in which coolant for cooling the heated engine 101 flows, a steering wheel 103 which is controlled by a user to determine a driving direction of the vehicle 100, a fuel tank 104 in which fuel to be supplied to the engine 101 is stored, and the like. Of course, there are no limits to the parts of the vehicle 100. In this embodiment of the present disclosure, only a few parts are given as an example for shortly describing the present inventive concept.

The detector 120 includes a plurality of sensors 121, 122, 123 and 124 to detect the parameters corresponding to various states of the vehicle 100. Each of sensors 121, 122, 123 and 124 is installed at a corresponding object to be measured by the sensors 121, 122, 123 and 124. For example, a first sensor 121 is installed at the engine 101, a second sensor 122 is installed at the cooling pipe 102, a third sensor 123 is installed at a rotary shaft of the steering wheel '103, and a fourth sensor 124 is installed at the fuel tank 104.

The sensors 121, 122, 123 and 124 may for example senses items as follows. The first sensor 121 measures the RPM of the engine 101 from the engine 101. The second sensor 122 measures the temperature of the coolant that flows in the cooling pipe 102 and cools the engine 101. The third sensor 123 measures a turned angle of the steering wheel 103. The fourth sensor 124 measures the amount of fuel remaining in the fuel tank 104. The items measured or detected by the sensors 121, 122, 123 and 124 may be related or unrelated to one another. Each of the sensors 121, 122, 123 and 124 transmits information about such detected or measured results to the processor 130.

The processor 130 may be materialized by an electronic control unit (ECU) or a processing board including a chipset, a circuit, a central processing unit (CPU), a system on chip (SOC) and the like, internally provided in the vehicle 100. The processor 130 collects the detected information received from each of the sensors 121, 122, 123 and 124 of the detector 120, and selectively processes the collected information with respect to preset references, thereby outputting the processed results.

The processor 130 includes a collection module 131 which collects the detected information received from the sensors 121, 122, 123 and 124, an analysis module 132 which determines the state of the vehicle 100 by analyzing the detected information collected in the collection module 131, and an alarm module 133 which transmits determination results of the analysis module 132 to the notifier 140. The collection module 131, the analysis module 132 and the alarm module 133 may be materialized by individual chipsets on the processor 130, or program codes of processors to be executed by the processor 130. The operations of the elements in the processor 130 will be described later.

The processor 130 may include additional elements or functions not described in an embodiment of the present disclosure, but only elements directly related to materialization of the present inventive concept will be described in this embodiment.

The notifier 140 may use one or more methods to notify a user of the information output from the processor 130. For example, the notifier 140 includes a display 141 to display an image, a loudspeaker 142 to output a sound, and the like. Besides, the notifier 140 may include elements materialized by various methods.

The display 141 may be materialized by a liquid crystal display (LCD) panel installed around a driver seat of the vehicle 100, or a transparent display installed in a front window of the vehicle 100. When information that the vehicle 100 is abnormal is received from the processor 130, the display 141 displays the information as a message or a user interface (UI). Further, when the information that the vehicle 100 is abnormal is received from the processor 130, the loudspeaker 142 outputs the information as a sound.

With this structure, the electronic apparatus 110 according to one embodiment operates as follows.

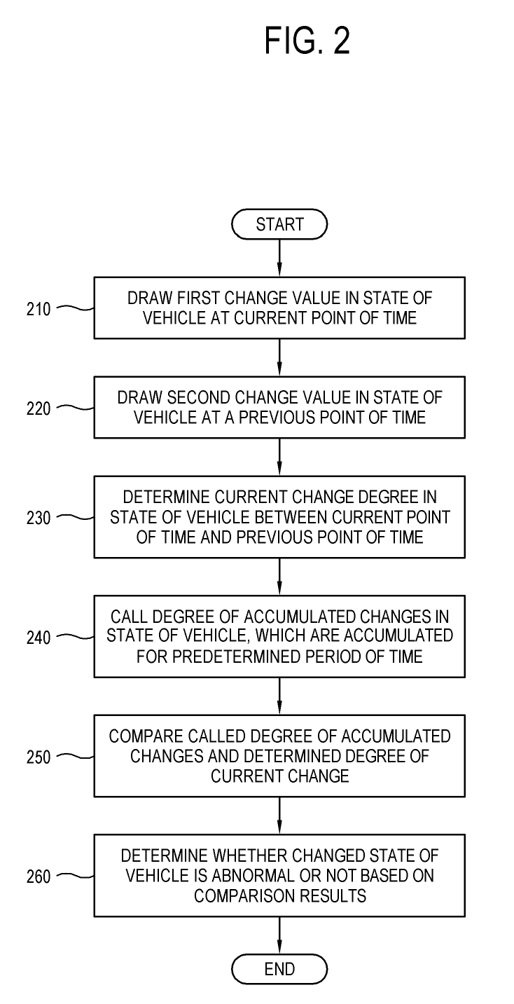

FIG. 2 is a flowchart illustrating operations of an electronic apparatus according to an embodiment of the present disclosure.

Referring to FIG. 2, the electronic apparatus senses the state of the vehicle at every unit time. Herein, the unit time refers to a value that may be determined by a preset design, e.g., may be applied in units of seconds. For example, the electronic apparatus pieces together the detected information collected from the sensors at a certain point of time to thereby draw a state value at the corresponding point of time. The detected information is represented in a scalar value, and the state value is represented in a vector value.

At operation 210 the electronic apparatus draws a first change value in a state of a vehicle at the current point of time. The first change value refers to a difference between the state value at the current point of time and the state value at a first point of time before the current point of time.

At operation 220 the electronic apparatus draws a second change value in the state of the vehicle at a previous point of time before the current point of time. The second change value refers to a difference between the state value at the first point of time before the current point of time and the state value at the second point of time before the first point of time.

At operation 230 the electronic apparatus determines a current change degree in the state of the vehicle between the current point of time and the previous point of time based on the first change value and the second change value. For example, the electronic apparatus determines similarity between development of change in the first change value and development of change in the second change value, thereby determining how similar or different a change aspect of the first change value and a change aspect of the second change value are to or from each other.

At operation 240 the electronic apparatus calls a degree of accumulated changes in the state of the vehicle, which are accumulated for a predetermined period of time before the current point of time. Such a degree of accumulated changes is drawn from a history value stored in the electronic apparatus, and a drawing principle is the same as described above. For example, the electronic apparatus calculates change values according to the points of time from the state values of the respective points of time for a predetermined period of time before the current point of time, calculates a degree of change in the state of the vehicle between two adjacent points of time from the drawn change values, and calculates a mean value of a plurality of calculated change degrees. This mean value may be used as the degree of accumulated changes.

At operation 250 the electronic apparatus compares the called degree of accumulated changes and the determined degree of current change.

At operation 260 the electronic apparatus determines whether the changed state of vehicle is abnormal or not based on comparison results. The electronic apparatus determines that the state change of the vehicle is normal when the degree of accumulated changes and the degree of current change are similar to each other. On the other hand, the electronic apparatus determines that the state change of the vehicle is abnormal when the degree of accumulated changes is different from the degree of current change.

Thus, the electronic apparatus can determine whether the changed state of the vehicle is abnormal or normal at the current point of time.

The reason why the electronic apparatus employs such a method according to this embodiment to determine whether the changed state of the vehicle is normal or abnormal is as follows. In case of the vehicle, there are many pieces of detected information detected by the detector, and violent changes in the detected information wholly occur while the vehicle is being driven. If only a value of the information about the state of the vehicle detected at one point of time is used to determine whether the vehicle is abnormal or not, accuracy in the determination is decreased. For example, even though a sharp change in the value of the state occurs up to a certain point of time, it is determined that the vehicle is normal if development of such a change in the value of the state has already occurred for a previous period of time. On the other hand, even though a gentle change in the value of the state occurs up to a certain point of time, it is determined that the vehicle is abnormal if development of change in the value of the state for a previous period of time is different from an aspect of such a change. The development of the change in the value of the state for the previous period of time is used as a criterion of determining the abnormality, and reflects the attributes of the vehicle.

Thus, the electronic apparatus according to this embodiment determines whether the change in the state of the vehicle by a lapse of time complies with the attributes of the vehicle, thereby ultimately having high accuracy in determining whether the state of the vehicle is normal or abnormal at the current point of time.

Below, operations of the collection module in the electronic apparatus will be described.

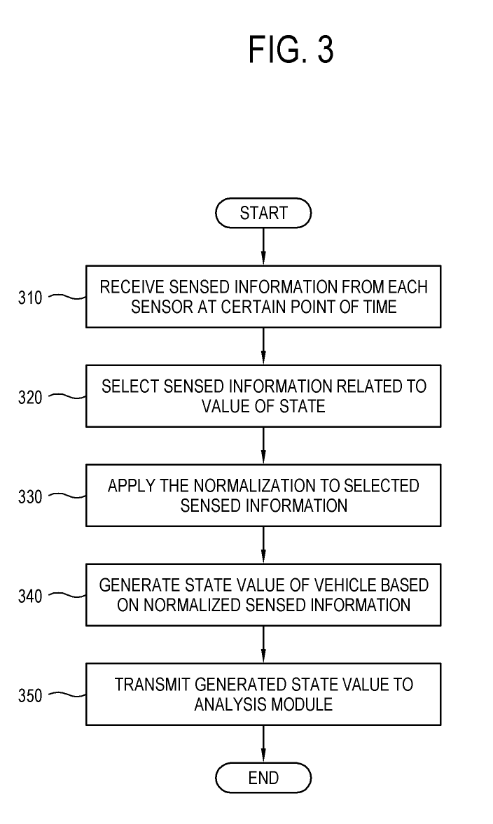

FIG. 3 is a flowchart illustrating operations of a collection module in an electronic apparatus according to an embodiment of the present disclosure.

Referring to FIG. 3, at operation 310 the collection module receives detected information from each sensor at the certain point of time.

At operation 320 the collection module selects pieces of detected information related to the value of the state among the received pieces of information. Herein, a criterion for the selection may be previously set, in which the features of the detected information to be applied to the value of the state are as follows. The detected information refers to digitized information, and information having a constant value or a continuously variable value as time goes by is applied to the value of the state. For example, the detected information always having a digitized value at any point of time is applied to the value of the state, whereas it is difficult to apply the detected information, which is irregularly obtained having a digitized value at a certain point of time but having no digitized value at another certain point of time, to the value of the state.

At operation 330 the collection module applies the normalization to the selected detected information. There are many normalization methods. In an embodiment of the present disclosure, for example, the min-max normalization may be used.

Various values respectively received from the plurality of sensors have many scales and are thus different in mean and deviation from one another. Therefore, the collection module processes the detected information to have the same scale without changing the features of time-series data in the detected information through the normalization. With this, all the values have the same scale, it is easy to compare or calculate the pieces of detected information according to the sensors. The min-max normalization may be represented in y=(x−min)/(max−min) Here, y is a new value, x is a current value, min is the minimum value, and the max is the maximum value. For example, if the maximum value and the minimum value of the time-series data are given, a new value may be output by normalizing a current value corresponding to a current value input.

At operation 340 the collection module generates a state value based on pieces of normalized detected information. There are many methods of generating the state value based on the pieces of detected information. For example, there is a method of generating a vector value by vectorizing the detected information of the scalar values.

At operation 350 the collection module transmits the generated state value of the vehicle at the certain point of time to the analysis module. In this case, the collection module may be store the state value as a history.

Below, operations of the analysis module in the electronic apparatus will be described.

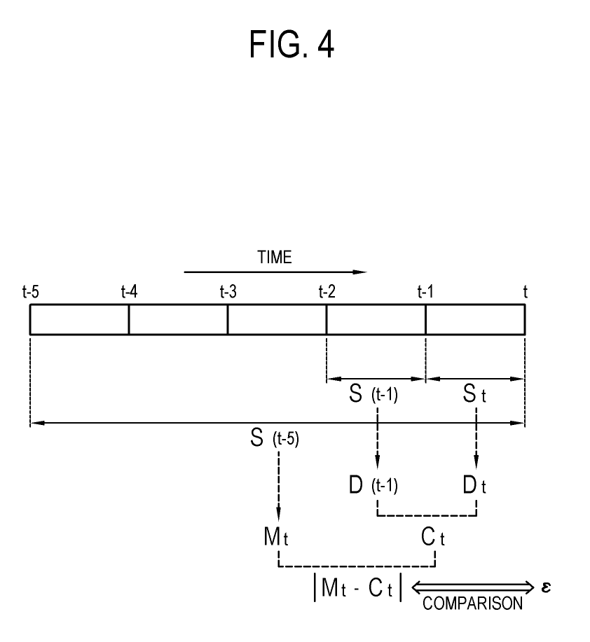

FIG. 4 illustrates a principle that an analysis module divides time sections for analysis of state changes in an electronic apparatus according to an embodiment of the present disclosure.

Referring to FIG. 4, a plurality of points of time is determined by a preset unit time interval as time goes on. For convenience, if the unit time is 1 second, a point of time t-1 is 1 second before the current point of time t, and a point of time t-2 is 1 second before the point of time t-1 and 2 seconds before the current point of time t. Likewise, a point of time t-5 is 5 seconds before the current point of time t.

A section from the point of time t-1 to the current point of time t will be called a time section Sₜ, a section from the point of time t-2 to the point of time t-1 will be called a time section S₍ₜ₋₁₎. Meanwhile, as an example of a predetermined time section before the current point of time t, a section from the point of time t-5 to the current point of time t will be called a time section S₍ₜ₋₅₎. The time section S₍ₜ₋₅₎ refers to a time section for 5 seconds before the current point of time t.

Let the state value of the vehicle at the current point of time t be Vₜ, the state value of the vehicle at the point of time t-1 be V₍ₜ₋₁₎. In this case, the change value Dₜ of the vehicle state at the time section Sₜ is as follows.

Dₜ=|Vₜ−V₍ₜ₋₁₎| Equation 1

For example, the change value of the vehicle state at the time section Sₜ is represented in a difference between the state value of the vehicle at the current point of time t and the state value of the vehicle at the point of time t-1. Herein, Vₜ is a k-dimensional vector including data measured at the point of time t. If a value of i^{th} detected information measured at the point of time t is represented as f_{i,t}, Vₜ may be for example represented with (f_{1,t}, f_{2,t}, . . . , f_{k,t}).

However, when there are no differences between the state at the point of time t-1 and the state at the current point of time t, Dₜ=0 in this Expression. In this case, a problem arises in subsequent calculation. Thus, this Expression has to be modified as follows.

Dₜ=|Vᵣ−V₍ₜ₋₁₎|+1 Equation 2

A value of “1” newly added to the foregoing Expression is an offset value to prevent Dₜ=0. The offset value is not limited to “1”, but may have various values in accordance with designs or formulae.

In accordance with the foregoing principle, the change value D₍ₜ₋₁₎ of the vehicle state in the time section S₍ₜ₋₁₎ is as follows.

D₍ₜ₋₁₎=|V₍ₜ₋₁₎−V₍ₜ₋₂₎|+1 Equation 3

For example, the change value of the vehicle state in the time section S₍ₜ₋₁₎ is represented in a difference between the state value V₍ₜ₋₁₎ of the vehicle at the point of time t-1 and the state value V₍ₜ₋₂₎ of the vehicle at the point of time t-2.

When the first change value Dₜ and the second change value D₍ₜ₋₁₎ are calculated, the analysis module calculates similarity between the first change value and the second change value as follows.

Cₜ=(Dₜ*D₍ₜ₋₁₎)/(|Dₜ||D₍ₜ₋₁₎|) Equation 4

In this Expression, “*” indicates a scalar product, i.e., a vector inner product. Cₜ indicates similarity between the first change value of the vehicle state in the time section Sₜ including the current point of time and the second change value of the vehicle state in the time section S₍ₜ₋₁₎. For example, this Expression shows how similar the development of the first change value and the development of the second change value are to each other, and is thus regarded as the current change degree of the vehicle state between the current point of time and its previous point of time.

Further, the analysis module calculates similarities between change values according to points of time in the time section S₍ₜ₋₅₎ from the point of time t-5 to the current point of time t. Each similarity is calculated by the same method as described above. Further, the analysis module calculates a mean value Mₜ of the similarities calculated in the time section S₍ₜ₋₅₎ as follows.

Mₜ=(ΣCᵢ)/5 Equation 5

In Σ calculation of this Expression, the first term is i=t-4 and the last term is t. Mₜ refers to a degree of accumulated changes in the state of the vehicle, which are accumulated during the time section S₍ₜ₋₅₎. Herein, there are no needs of limiting the time section to S₍ₜ₋₅₎, and there are no limits to the length of the time. Further, the time section may include or exclude the current point of time. For example, the analysis module may select a time section from the point of time t-5 to the point of time t-1 without including the current point of time t.

Mₜ, i.e., the degree of accumulated changes of the vehicle state, which is to show the attributes of the normal vehicle, may be determined based on various time sections before the current point of time. Further, according to designs, the analysis module may call the value previously designated for the vehicle without calculating the degree of accumulated changes of the vehicle state from a predetermined time section like this Expression.

This Expression is normalized as follows.

Mₜ=(ΣCᵢ)/n Equation 6

In Σ calculation of this Expression, the first term is i=t−(n-1) and the last term is t. Here, n is the length of a predetermined time section by the unit time. When the unit time is given in units of second, and a predetermined time section corresponds to 5 seconds, Expression 5 is represented in the Expression 4.

When Cₜ and Mₜ are drawn, the analysis module performs determination as shown in the following Expression.

|Mₜ−Cₜ|≥ϵ; normal

|Mₜ−Cₜ|<ϵ; abnormal Equation 7

The threshold value ϵ is a value determined by previous experiments or simulations, and is not limited to a specific numerical value. The threshold value ϵ may be prepared when designing or manufacturing the vehicle or the electronic apparatus. Alternatively, the electronic apparatus may update c based on a use history of the vehicle.

|Mₜ−Cₜ| indicates how similar Mₜ are Cₜ with regard to a degree of change. When this value is high, it denotes that a degree of change in Cₜ is slight as compared with Mₜ and they are relatively similar to each other. On the other hand, when this value is low, it denotes that a degree of change in Cₜ is large as compared with Mₜ and they are relatively different from each other.

Therefore, the result of |Mₜ−Cₜ|≥ϵ means that a degree of change in the vehicle state at the current point of time is similar to that of the normal vehicle state. Thus, the analysis module determines that the change in the vehicle state at the current point of time is normal.

On the other hand, the result of |Mₜ−Cₜ|<ϵ means that a degree of change in the vehicle state at the current point of time is different from that of the normal vehicle state. Thus, the analysis module determines that the change in the vehicle state at the current point of time is abnormal.

With these processes, the analysis module determines whether the vehicle state at the current point of time is normal or abnormal.

In the foregoing embodiments of the present disclosure, Expression 4 makes an application of cosine similarity. The cosine similarity refers to a degree of similarity between vectors measured using a cosine value of an angle between two vectors in an inner product space. When the angle is 0, the cosine value is 1. Regarding the other angles, the cosine value is smaller than 1. Therefore, the cosine value is used for determining not a magnitude of a vector but similarity in a direction of the vector. When two vectors have the same direction, the cosine value is 1. When two vectors form an angle of 90 degrees with each other, the cosine value is 0. In this case, the magnitude of the vector does not have any effect on the value.

More particularly, the cosine similarity is used in a positive number space where a result value is within the range of [0, 1].

The cosine similarity is applicable to any number of dimensions, and often used in measuring similarity in a positive number space of a multi-dimension.

The cosine value between two vectors may be derived from the Euclidian scalar product. For example, when vector values having attributes of A and B are given, the cosine similarity cos(θ) is represented as follows.

cos(θ)=(A*B)/(∥A∥∥B∥)

A*B=Σ(Aᵢ×Bᵢ)

∥A∥∥B∥=[√{Σ(Aᵢ)²}]×[√{Σ(Bᵢ)²}] Equation 8

In all Σ calculations of this Expression, the first term is i=1, and the last term is n. When such a calculated similarity is 0, two vectors are independent of each other. When the similarity is 1, two vectors are the same with each other.

With this principle, the analysis module determines similarity by the method as described above.

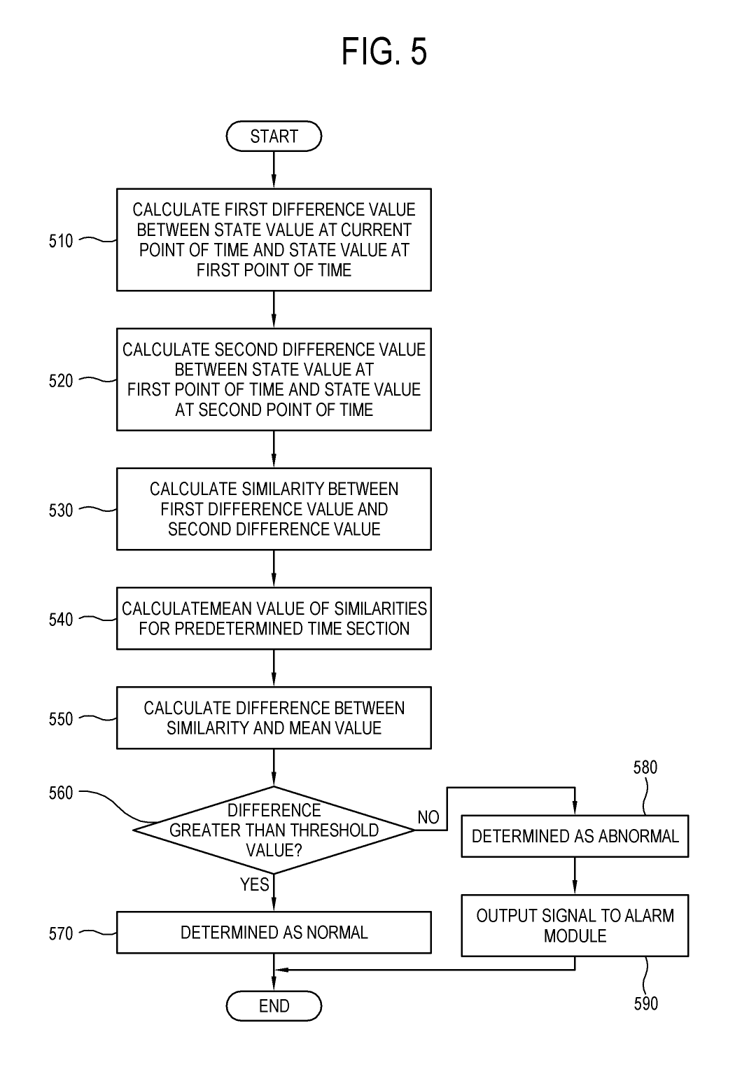

FIG. 5 is a flowchart illustrating operations of an analysis module in an electronic apparatus according to an embodiment of the present disclosure.

Referring to FIG. 5, at operation 510 the analysis module calculates a first difference value between a state value at the current point of time and a state value at a first point of time. Herein, the first point of time is earlier than the current point of time.

At operation 520 the analysis module calculates a second difference value between the state value at the first point of time and a state value at a second point of time. Herein, the second point of time is earlier than the first point of time.

At operation 530 the analysis module calculates a similarity between the first difference value and the second difference value. The similarity may be calculated by the foregoing principle as described above, but various similarity calculation methods may be applicable.

At operation 540 the analysis module calculates a mean value of the similarities for a predetermined time section before the current point of time. Such similarities are obtained with regard to the difference values derived from the state values at the points of time within the predetermined time section, on the same principle as that of the operation 530.

At operation 550 the analysis module calculates a difference between the similarity from the operation 530 and the mean value from the operation 540.

At operation 560 the analysis module determines whether the difference calculated in the operation 550 is greater than a preset threshold value.

When the difference is greater than the threshold value, at operation 570 the analysis module determines that the vehicle state is normal at the current point of time.

On the other hand, when the difference is not greater than the threshold value, at operation 580 the analysis module determines that the vehicle state is abnormal at the current point of time. At operation 590 the analysis module outputs a signal for informing abnormality to the alarm module.

With these operations, the analysis module determines whether the vehicle state is normal or abnormal at the current point of time.

When receiving a signal for informing the abnormality of the vehicle state from the analysis module, the alarm module processes the signal in various preset methods. For example, the alarm module outputs a control signal so that the display provided in the vehicle can display a warning message or the loudspeaker provided in the vehicle can output a warning sound or a guide sound. The display may be materialized by a display panel installed around a driver seat of the vehicle, or a transparent display installed in a front window of the vehicle.

By the way, an element for informing a user of the abnormality of the vehicle is not limited to the element provided in the vehicle.

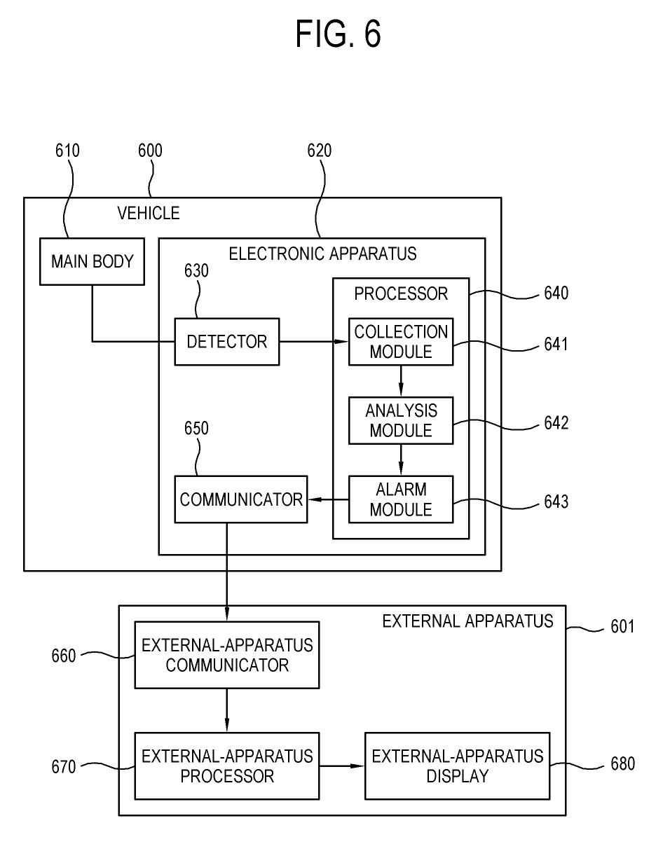

FIG. 6 is a block diagram of an electronic apparatus according to an embodiment of the present disclosure.

Referring to FIG. 6, a vehicle 600 includes a main body 610, and an electronic apparatus 620 for determining whether the main body 610 is normal or abnormal by monitoring the operations of the main body 610. The electronic apparatus 620 includes a detector 630 and a processor 640, and the processor 640 includes a collection module 641, an analysis module 642, and an alarm module 643. These elements have substantially the same functions and operations as those described in the foregoing embodiments. Further, the electronic apparatus 620 according to one embodiment may additionally include a communicator 650 to communicate with an external apparatus 601.

The communicator 650 includes a hardware communication chip, a communication port or a communication circuit, and supports a preset communication protocol. The communicator 650 can communicate with the external apparatus 601 that supports common communication protocols. The communicator 650 may support one of wireless and wired communication protocols. When it is taken into account that the external apparatus 601 provided as a mobile apparatus is advantageous in a utility aspect, the communicator 650 may support wireless communication protocols, such as ZigBee, Bluetooth, Wi-Fi Direct, and the like.

The detector 630 detects various states of the main body 610, and transmits detected information based on detected results to the collection module 641. The collection module 641 selects many pieces of detected information. The analysis module 642 determines whether the state of the main body is normal or abnormal based on the selected detected information, and transmits a signal based on determination results to the alarm module 643 when the state of the main body 610 is abnormal.

The alarm module 643 transmits the signal of the abnormality to the communicator 650, and the communicator 650 transmits the received signal to the external apparatus 601.

The external apparatus 601 may be for example achieved by a smart phone or the like mobile apparatus. The external apparatus 601 includes an external-apparatus communicator 660, an external-apparatus processor 670, and an external-apparatus display 680. The external-apparatus communicator 660 includes a communication chip, a communication circuit, and the like. The external-apparatus processor 670 includes a circuit that includes at least one of a processor, an SoC, a microprocessor, a chipset, and a CPU. The external-apparatus display 680 includes one of various display panels, such as an LCD and the like.

The external-apparatus communicator 660 receives a signal from the electronic apparatus 620, specifically, from the alarm module 643, and transmits it to the external-apparatus processor 670. The external-apparatus processor 670 processes the received signal so that the external-apparatus display 680 can display a UI or message for informing the abnormality of the vehicle 600.

Thus, the electronic apparatus 620 can inform a user of the abnormality of the vehicle 600 through the external apparatus 601.

Herein, the electronic apparatus may perform an additional operation for a user's convenience while displaying a UI for informing the abnormality of the vehicle on its own display or an external apparatus.

For example, the electronic apparatus determines a current location of a vehicle when it is determined that the vehicle is abnormal at the current point of time. The electronic apparatus determines the nearest repair shop to the current location of the vehicle, and displays a global positioning system (GPS) UI for indicating the repair shop on the display. Thus, a user recognizes the abnormal state of the vehicle and the nearest repair shop for the vehicle.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read-Only Memory (ROM), a Random-Access Memory (RAM), Compact Disc-ROMs (CD-ROMs), magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. An apparatus comprising:
a detector configured to detect a state of the apparatus; and
at least one processor configured to:
determine a current change degree of an apparatus state between a current point of time and a previous point of time based on a first change value of the apparatus state at the current point of time and a second change value of the apparatus state at the previous point of time earlier than the current point of time, and
determine whether change in the apparatus state is normal or abnormal based on a result of comparison between the determined current change degree and an accumulated change degree of the apparatus state accumulated for a predetermined time section before the current point of time.

2. The apparatus of claim 1, wherein the at least one processor is further configured to:
determine that the change in the apparatus is normal when a difference between the determined current change degree and the accumulated change degree is relatively large, and
determine that the change in the apparatus state is abnormal when the difference is relatively small.

3. The apparatus of claim 2, further comprising a display,
wherein the at least one processor is further configured to process a user interface (UI), which informs the abnormality of the apparatus state, to be displayed on the display when it is determined that the change in the apparatus state is abnormal.

4. The apparatus of claim 2, wherein the at least one processor is further configured to determine the current change degree by determining similarity between the first change value and the second change value based on cosine similarity.

5. The apparatus of claim 2, wherein the at least one processor is further configured to:
calculate change values in the apparatus state at a plurality of points of time within the predetermined time section based on cosine similarity, and
determine the accumulated change degree of the apparatus states based on a mean value of the calculated change values.

6. The apparatus of claim 1, wherein the at least one processor is further configured to calculate the first change value based on a first difference value between a state value of showing the apparatus state at the current point of time and a state value of showing the apparatus state at the first point of time before the current point of time.

7. The apparatus of claim 6, wherein the at least one processor is further configured to calculate the second change value based on a second difference value between the state value at the first point of time and the state value of showing the apparatus state at a second point of time before the first point of time.

8. The apparatus of claim 6,
wherein the detector comprises a plurality of sensors configured to detect the states of the apparatus, and
wherein the at least one processor is further configured to generate the state value of the apparatus at the points of time by vectorizing pieces of detected information respectively output from the plurality of sensors at a certain point of time.

9. A method of controlling an apparatus, the method comprising:
detecting a state of the apparatus;
determining a current change degree of an apparatus state between a current point of time and a previous point of time based on a first change value of the apparatus state at the current point of time and a second change value of the apparatus state at the previous point of time earlier than the current point of time; and
determining whether change in the apparatus state is normal or abnormal based on a result of comparison between the determined current change degree and an accumulated change degree of the apparatus state accumulated for a predetermined time section before the current point of time.

10. The method of claim 9, wherein the determining of whether the change in the apparatus state is normal or abnormal comprises:
determining that the change in the apparatus is normal when a difference between the determined current change degree and the accumulated change degree is relatively large; and
determining that the change in the apparatus state is abnormal when the difference is relatively small.

11. The method of claim 10, wherein the determining of that the change in the apparatus state is abnormal comprises displaying a user interface (UI) which informs the abnormality of the apparatus state.

12. The method of claim 10, wherein the determining of the current change degree of the apparatus state comprises determining of the current change degree by determining similarity between the first change value and the second change value based on cosine similarity.

13. The method of claim 10, wherein the determining of whether the change in the apparatus state is normal or abnormal comprises:
calculating change values in the apparatus state at a plurality of points of time within the predetermined time section based on cosine similarity; and
determining the accumulated change degree of the apparatus states based on a mean value of the calculated change values.

14. The method of claim 9, wherein the determining of the current change degree of the apparatus state comprises calculating the first change value based on a first difference value between a state value of showing the apparatus state at the current point of time and a state value of showing the apparatus state at the first point of time before the current point of time.

15. The method of claim 14, wherein the determining of the current change degree of the apparatus state comprises calculating the second change value based on a second difference value between the state value at the first point of time and the state value of showing the apparatus state at a second point of time before the first point of time.

16. The method of claim 14, wherein the detecting of the states of the apparatus comprises generating the state value of the apparatus at the points of time by vectorizing pieces of detected information respectively output from a plurality of sensors at a certain point of time.

17. At least one non-transitory recording medium, in which a program code of a method provided to be implemented by at least one processor of an apparatus is stored, the recording medium comprising:
detecting a state of the apparatus;
determining a current change degree of an apparatus state between a current point of time and a previous point of time based on a first change value of the apparatus state at the current point of time and a second change value of the apparatus state at the previous point of time earlier than the current point of time; and
determining whether change in the apparatus state is normal or abnormal based on a result of comparison between the determined current change degree and an accumulated change degree of the apparatus state accumulated for a predetermined time section before the current point of time.
